(19) United States
(12) Patent Application Publication
(10) Pub. No.: US 2018/0074092 A1
(43) Pub. Date: Mar. 15, 2018

(54) INFORMATION ACQUIRING METHOD IN ATOMIC FORCE MICROSCOPE

(71) Applicant: OLYMPUS CORPORATION, Tokyo (JP)

(72) Inventor: Nobuaki SAKAI, Hachioji-shi (JP)

(73) Assignee: OLYMPUS CORPORATION, Tokyo (JP)

(21) Appl. No.: 15/813,272

(22) Filed: Nov. 15, 2017

Related U.S. Application Data
(63) Continuation of application No. PCT/JP2015/064050, filed on May 15, 2015.

(51) Int. Cl. G01Q 10/02

(52) U.S. Cl. CPC G01Q 10/02

(57) ABSTRACT

An information acquiring method in an atomic force microscope includes, during causing the microscope to raster scan a cantilever and a sample relatively while causing a mechanical interaction between the sample and a probe provided at a free end of the cantilever, causing a first interaction having first strength between the probe and sample, acquiring first information on the sample when the first interaction is generated, causing a second interaction having second strength between the probe and sample, and acquiring second information on the sample when the second interaction is generated. The first strength and second strength are different. The causing the first interaction, the acquiring the first information, the causing the second interaction, and the acquiring the second information are performed in a same scanning region.

### CROSS REFERENCE TO RELATED APPLICATIONS

This application is a Continuation Application of PCT Application No. PCT/JP2015/064050, filed May 15, 2015, the entire contents of which are incorporated herein by reference.

### BACKGROUND OF THE INVENTION

### 1. Field of the Invention

The present invention relates to scanning probe microscopes, in particular, atomic force microscopes for use in observation of living body samples.

### 2. Description of the Related Art

The scanning probe microscope (SPM), which is a scanning microscope to acquire information on a sample surface by mechanically scanning a mechanical probe, is a common name for a scanning tunneling microscope (STM), atomic force microscope (AFM), scanning magnetic force microscope (MFM), scanning capacitance microscope (SCaM), scanning near-field optical microscope (SNOM), and the like.

A scanning type probe microscope can raster scan a mechanical probe and a sample relatively in an XY direction to acquire desired surface information on the sample through the mechanical probe, mapping and displaying the information on a display. Of these, the atomic force microscope (hereinafter, referred to as AFM), which is the most widely used device, comprises a cantilever having a mechanical probe at its free end, an optical displacement sensor to detect a displacement of the cantilever, and a scanner to relatively scan the cantilever and a sample. The AFM causes a mechanical interaction to be generated between the mechanical probe and the sample to acquire information on the sample based on deformation of the cantilever caused by the mechanical interaction.

Recently, a living body video observation AFM capable of observing appearance of a living biological sample moving in a liquid is receiving attention. In the living body video observation AFM also allows observing a living cell in a liquid. Most recently, an example that has singularly acquired information on a cell surface and information on a organelle present inside the cell, for example, information on actin filament and mitochondria, respectively, is released in Yoshida A, Sakai N, Uekusa Y, Deguchi K, Gilmore J L, Kumeta M, Ito S, Takeyasu K. (2015) “Probing in vivo dynamics of mitochondria and cortical actin networks using high-speed atomic force/fluorescence microscopy”, Genes Cells, 2015 Feb., 20 (2):85-94.

### BRIEF SUMMARY OF THE INVENTION

The present invention is directed to an information acquiring method in an atomic force microscope to acquire information on a sample by raster scanning a cantilever and the sample across an XY-plane, while contacting a probe provided at a free end of the cantilever with the sample to cause a mechanical interaction to be generated between the probe and the sample. The method includes causing a first interaction having first strength to be generated between the probe and the sample, acquiring first information on the sample when the first interaction is generated between the probe and the sample, causing a second interaction having second strength to be generated between the probe and the sample, and acquiring second information on the sample when the second interaction is generated between the probe and the sample. The first strength of the first interaction and the second strength of the second interaction are different from each other. The causing the first interaction to be generated, the acquiring the first information, the causing the second interaction to be generated, and the acquiring the second information are performed in a same scanning region.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute apart of the specification, illustrate embodiments of the invention, and together with the general description given above and the detailed description of the embodiments given below, serve to explain the principles of the invention.

FIG. 1 shows a configuration of an atomic force microscope that may be commonly used in embodiments;

FIG. 2 shows the movement of relative raster scanning of the cantilever 102 with respect to the sample 103;

FIG. 3 shows an X-scanning signal and a Y-scanning signal for performing the raster scanning shown in FIG. 2;

FIG. 4 is a flow chart of an information acquiring method in an atomic force microscope according to a first embodiment;

FIG. 5 shows an X-scanning signal and a Y-scanning signal, and first information on a sample and second information on the sample displayed on a sample-information display, in the information acquiring method according to the first embodiment;

FIG. 6 shows a cell as the sample;

FIG. 7 shows an example where the region F of the cell shown in FIG. 6 is observed with the interaction being reduced;

FIG. 8 shows an example where the region F of the cell shown in FIG. 6 is observed with the interaction being increased;

FIG. 9 shows an example of an observation image displayed on the sample-information display by the information acquiring method according to the first embodiment;

FIG. 10A highlights a forward path of the single scanning line of the raster scanning of the cantilever with respect to the sample;

FIG. 10B highlights a backward path of the single scanning line of the raster scanning of the cantilever with respect to the sample;

FIG. 11A shows an X-scanning signal and a Y-scanning signal for performing the raster scanning, and highlights a portion of the X-scanning signal corresponding to the forward path highlighted in FIG. 10A;

FIG. 11B shows the X-scanning signal and the Y-scanning signal for performing the raster scanning, highlights a portion of the X-scanning signal corresponding to the backward path highlighted in FIG. 10B;

FIG. 12 is a flow chart of an information acquiring method in an atomic force microscope according to a second embodiment;

FIG. 13 shows an X-scanning signal, and first information on a sample and second information on the sample displayed on the sample-information display, in the information acquiring method according to the second embodiment;

FIG. 14 is a flow chart of an information acquiring method in an atomic force microscope according to a modification of the second embodiment;

FIG. 15 shows an X-scanning signal, and first information on a sample and second information on the sample displayed on the sample-information display, in the information acquiring method according to the modification of the second embodiment;

FIG. 16 is a flow chart of an information acquiring method in an atomic force microscope according to a third embodiment;

FIG. 17 shows an X-scanning signal and a Y-scanning signal, and first information on a sample and second information on the sample displayed on the sample-information display, in the information acquiring method according to the third embodiment;

FIG. 18 is a flow chart of an information acquiring method in an atomic force microscope according to a fourth embodiment;

FIG. 19 shows an example of an observation image displayed on the sample-information display by an information acquiring method according to a fourth embodiment;

FIG. 20 is a flow chart of an information acquiring method in an atomic force microscope according to a fifth embodiment; and

FIG. 21 is a flow chart of an information acquiring method in an atomic force microscope according to a sixth embodiment.

### DETAILED DESCRIPTION OF THE INVENTION

### Atomic Force Microscope

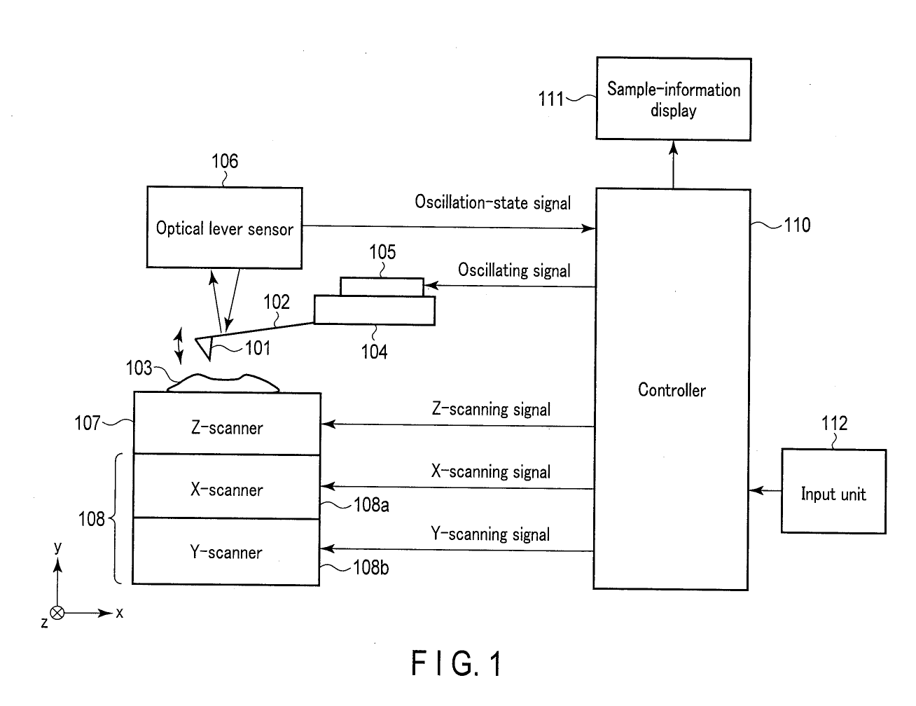

Prior to explanations of embodiments of an information acquiring method in an atomic force microscope, a configuration of an atomic force microscope that may be commonly used in the embodiments will be explained using FIGS. 1 to 3. FIG. 1 shows the configuration of the atomic force microscope.

The atomic force microscope includes a cantilever 102 having a probe 101 at the free end. The cantilever 102 is placed so that the probe 101 faces a sample 103. The cantilever 102 is held by a holder 104.

A piezoelectric element 105 is provided on the holder 104. The piezoelectric element 105 operates as an oscillator to oscillate the cantilever 102 through the holder 104. The piezoelectric element 105 oscillates the cantilever 102 based on an oscillating signal output from a controller 110. The oscillating signal contains an alternating component to oscillate the cantilever 102 near its mechanical resonance frequency.

Above the cantilever 102, an optical lever sensor 106 for optically detecting a displacement of the cantilever 102 is placed. The optical sensor 106 outputs an oscillation-state signal of the cantilever 102. The oscillation-state signal is supplied to the controller 110.

The sample 103 is held on a Z-scanner 107 through an unillustrated sample stage, and the Z-scanner 107 is placed on an XY-scanner 108. The XY-scanner 108 comprises an X-scanner 108a, and a Y-scanner 108b. The sample 103 is in an unillustrated liquid cell. The sample 103 is, for example, a living cell in a liquid.

The Z-scanner 107 is to scan the sample 103 along a Z direction with respect to the cantilever 102. The Z-scanner 107, which is controlled by the controller 110, extends and contracts along the Z direction based on a Z-scanning signal output from the controller 110, so as to scan the sample 103 along the Z direction with respect to the cantilever 102. The Z-scanning signal is a signal for controlling the Z-scanner 107 so as to keep, for example, an amplitude value of the oscillation-state signal of the cantilever 102 constant, and by the Z-scanning signal, a relative distance between the cantilever 102 and the sample 103 along the Z direction is controlled. That is, the controller 110 can control the strength of the mechanical interaction between the probe 101 and the sample 103.

The XY-scanner 108 is to raster scan the sample 103 with respect to the cantilever 102 across an XY-plane. The X-scanner 108a and the Y-scanner 108b constituting the XY-scanner 108 are controlled by the controller 110, and are displaced along an X direction and a Y direction based on the X-scanning signal and the Y-scanning signal, respectively, so as to raster scan the sample 103 with respect to the cantilever 102 across the XY-plane.

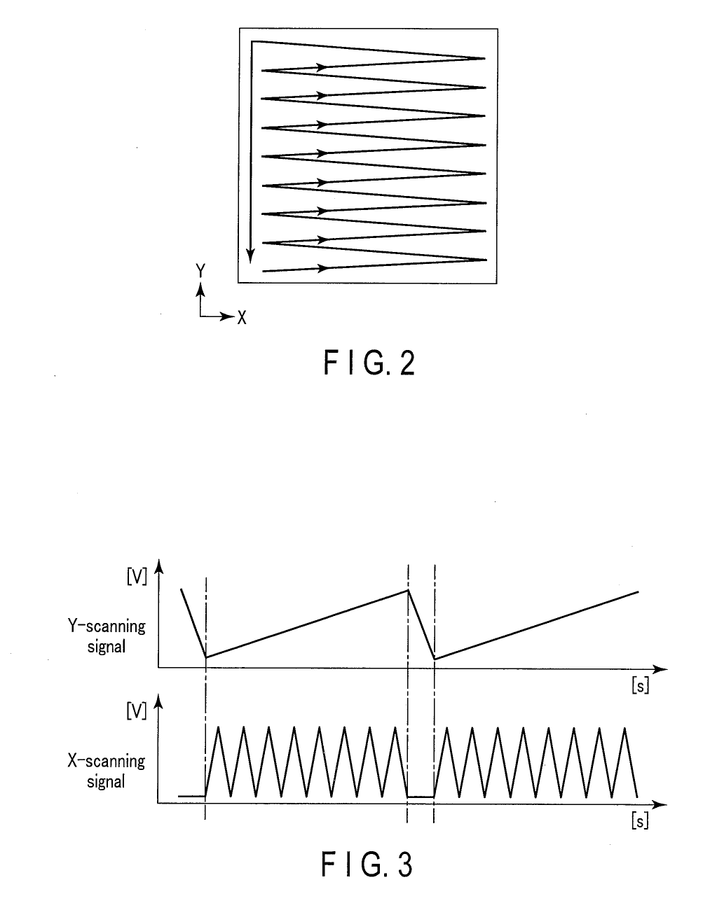

FIG. 2 shows the movement of relative raster scanning of the cantilever 102 with respect to the sample 103. The movement of the raster scanning is a conventional and common one. In FIG. 2, a scanning line direction of the raster scanning (a direction in which the scanning speed is fast) is assumed as an X direction.

FIG. 3 shows an X-scanning signal and a Y-scanning signal for performing the raster scanning shown in FIG. 2.

The controller 110 generates and acquires image data for mapping information on the sample based on the X-scanning signal, Y-scanning signal, and Z-scanning signal, supplying it to a sample-information display 111.

The sample-information display 111, which is, for example, a monitor, displays the image data acquired by the controller 110, i.e., sample information.

The controller 110 is connected to an input unit 112. The input unit 112 is, for example, to install a program to cause the controller 110 to execute the information acquiring method according to each embodiment disclosed herein into the controller 110 to control the atomic force microscope, to designate an observation region, and to give a command such as a start of observation and an end of observation to the controller 110.

### First Embodiment

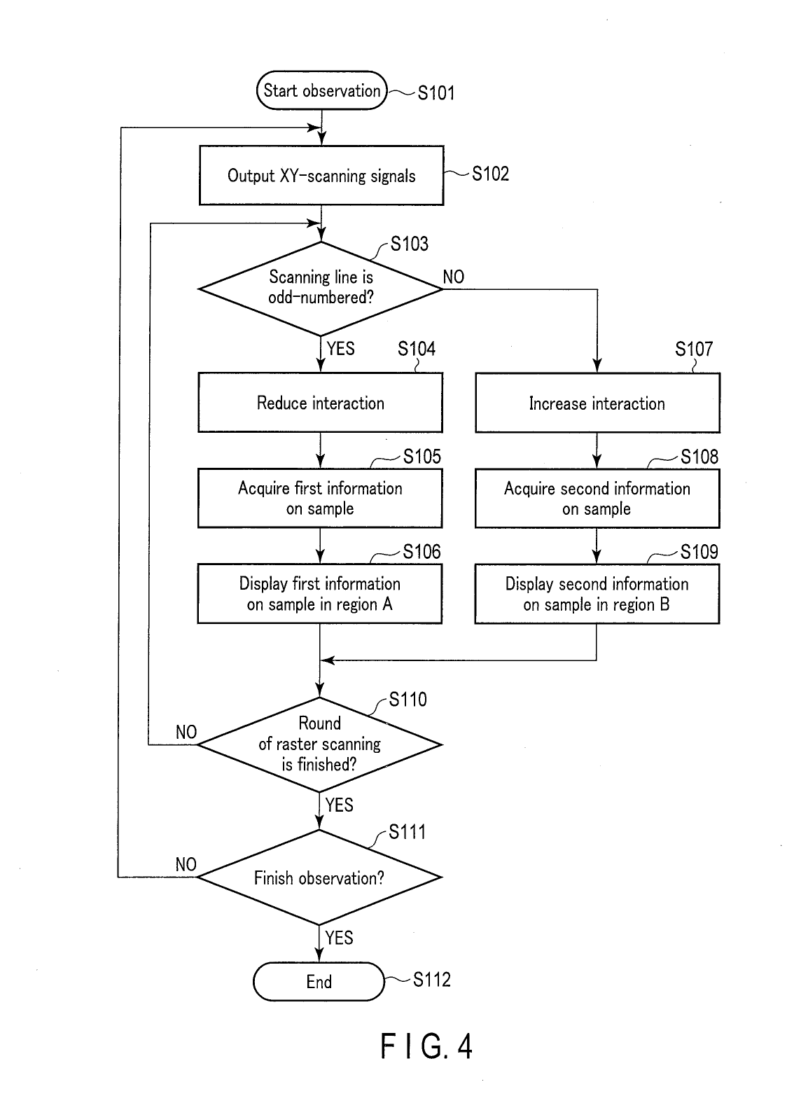

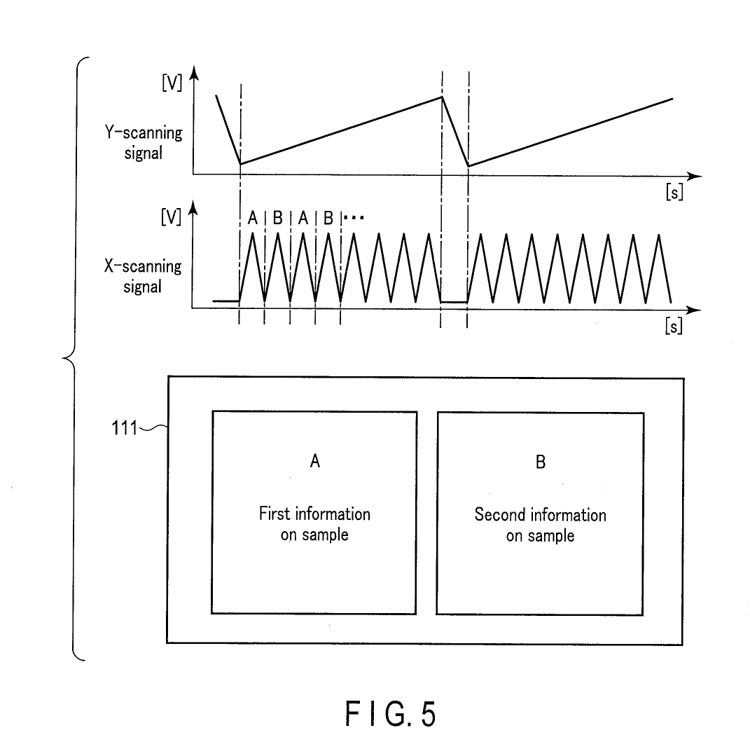

Next, an information acquiring method in an atomic force microscope according to a first embodiment will be explained using FIGS. 4 and 5. FIG. 4 is a flow chart of the information acquiring method in an atomic force microscope according to the first embodiment. FIG. 5 shows an X-scanning signal and a Y-scanning signal, and first information on a sample 103 and second information on the sample 103 displayed on the sample-information display 111, in the information acquiring method according to the first embodiment.

The information acquiring method according to the present embodiment is a technique of alternately acquiring the first information on the sample 103 and the second information on the sample 103 for each single scanning line of a round of the raster scanning.

In step S101, observation (acquisition of information on a sample) is started. An oscillating signal is output from the controller 110 and is supplied to the piezoelectric element 105, which operates as the oscillator. The piezoelectric element 105 oscillates the cantilever 102 near its mechanical resonance frequency based on the oscillating signal. The optical lever sensor 106 placed above the cantilever 102 detects an oscillation state of the cantilever 102, supplying the oscillation-state signal to the controller 110. The controller 110 generates a Z-scanning signal based on the oscillation-state signal, causing the Z-scanner 107 to expand and contract to control a relative distance between the sample 103 and the cantilever 102 along the Z direction.

In step S102, the controller 110 outputs the X-scanning signal and the Y-scanning signal. The XY-scanner 108 receives the X-scanning signal and the Y-scanning signal to start the raster scanning of the sample 103 with respect to the cantilever 102 across the XY-plane.

In step S103, the controller 110 determines whether the present scanning line (scanning line based on the X-scanning signal) of the raster scanning is an odd-numbered line or an even-numbered line. Herein, it is assumed that the single scanning line corresponds to a back-and-forth movement relating to the X direction.

As a result of the determination in step S103, if the scanning line is the odd-numbered line, e.g., the first line, the controller 110 adjusts, in step S104, a relative distance between the cantilever 102 and the sample 103 along the Z direction to adjust the mechanical interaction between the cantilever 102 and the sample 103, causing a first interaction having a first strength to be generated between the probe 101 and the sample 103. For example, the controller 110 increases the relative distance between the cantilever 102 and the sample 103 along the Z direction to reduce the mechanical interaction between the probe 101 and the sample 103, causing the first interaction having the first strength to be generated between the probe 101 and the sample 103.

In step S105, the controller 110 generates and acquires image data for the single scanning line for mapping the first information on the sample 103, i.e., first information on the sample 103 for the single scanning line, based on the X-scanning signal, the Y-scanning signal, and the Z-scanning signal. The first information on the sample 103 is information on the sample when a small interaction is generated between the probe 101 and the sample 103, e.g., information on a surface of the sample.

In step S106, the sample-information display 111 displays the image data for the single scanning line acquired by the controller 110, i.e., the first information on the sample 103 for the single scanning line, in a region A shown in FIG. 5 for the single scanning line. If the scanning line is the odd-numbered line, namely, if the X-scanning signal is present in a range A shown in FIG. 5, the sample-information display 111 displays the first information on the sample 103 in the region A shown in FIG. 5.

As a result of the determination in step S103, if the scanning line is the even numbered line, e.g., the second line, the controller 110 reduces, in step S107, the relative distance between the cantilever 102 and the sample 103 along the Z direction to increase the mechanical interaction between the probe 101 and the sample 103, causing a second interaction having a second strength to be generated between the probe 101 and the sample 103. The second strength of the second interaction is larger than the first strength of the first interaction.

In step S108, the controller 110 generates and acquires image data for the single scanning line for mapping the second information on the sample 103, i.e., second information on the sample 103 for the single scanning line, based on the X-scanning signal, the Y-scanning signal, and the Z-scanning signal. The second information on the sample 103 is sample information when a large interaction is generated between the probe 101 and the sample 103, for example, it is information on the sample's interior.

In step S109, the sample-information display 111 displays the image data for the single scanning line acquired by the controller 110, i.e., the second information on the sample 103 for the single scanning line, in a region B shown in FIG. 5 for the single scanning line. If the scanning line is the even-numbered scanning line, namely, if the X-scanning signal is present in a range B shown in FIG. 5, the sample-information display 111 displays the second information on the sample 103 in the region B shown in FIG. 5.

After step S106 or step S109, in step S110, the controller 110 determines whether a round of the raster scanning is finished or not. As a result of the determination in step S110, if the round of the raster scanning has not been finished, the controller 110 returns to step S103 and repeats the steps S103 to S110 until the round of the raster scanning is finished. As a result, the first information on the sample 103 displayed in region A in FIG. 5 and the second information on the sample 103 displayed in the region B in FIG. 5 are updated and displayed alternately at temporally equal intervals.

At the point in time when the round of the raster scanning is finished, displaying the first information on the sample 103 when the interaction is small and the second information on the sample 103 when the interaction is large, in the region A and the region B shown in FIG. 5 for all scanning lines, has become completed.

The controller 110 determines, in step S111, whether to finish the observation, in other words, whether to perform the next raster scanning, i.e., whether to perform the observation once more (whether to acquire information on the sample once more).

As a result of the determination in step S111, if the observation should be performed once more, the controller 110 returns to step S102.

As a result of the determination in step S111, if the observation needs to be finished, the observation is finished in step S112.

The information acquiring method according to the present embodiment alternately acquires, for each single scanning line, two kinds of information on the sample for large and small strengths in the mechanical interaction between the probe 101 and the sample 103, in other words, at temporally equal intervals corresponding to scanning for the single scanning line. This is deemed that the two kinds of information on the sample are acquired at approximately the same time. Therefore, it is possible to acquire the information on the mutual relationship between them.

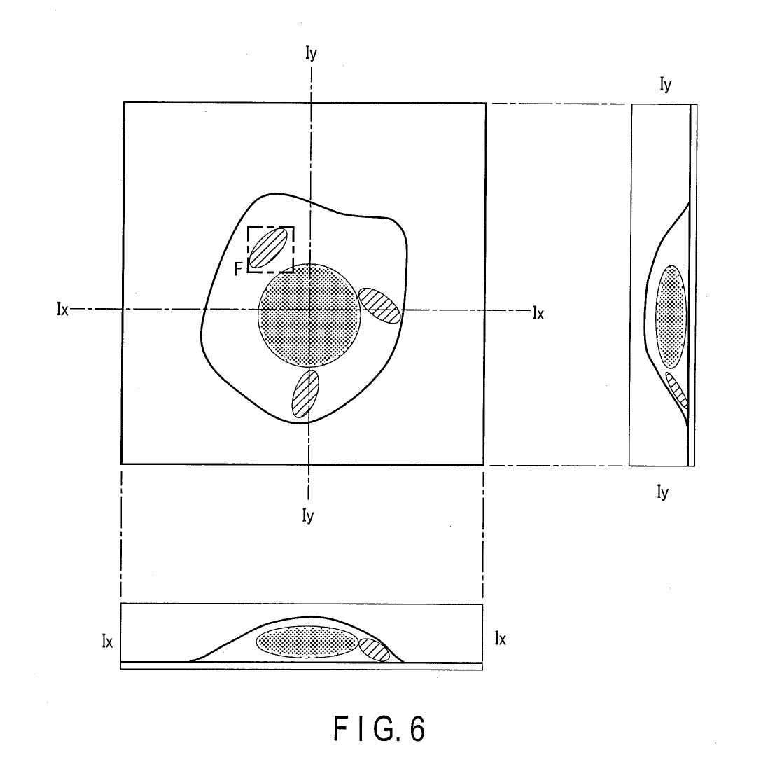

Specific examples thereof are shown below. The sample 103 is assumed as a cell shown in FIG. 6. A region F shown in FIG. 6 is assumed to be observed by an AFM.

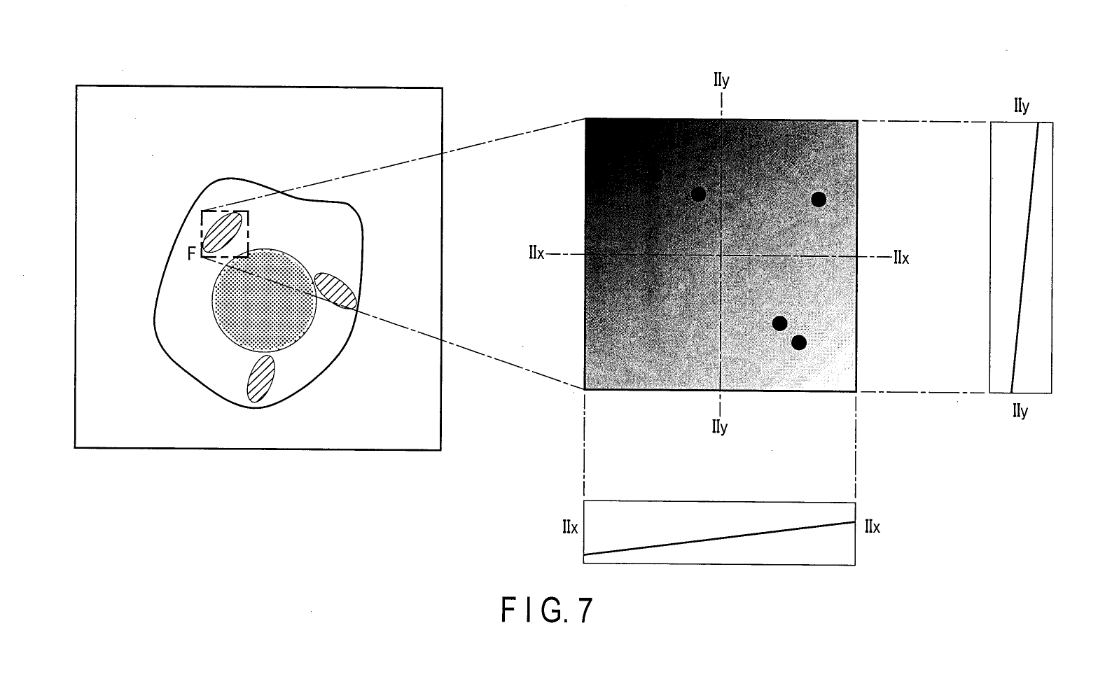

FIG. 7 shows an example where the region F of the cell shown in FIG. 6 is observed with the interaction being reduced. If the interaction is small, cell membrane surface information on the cell can be obtained, so that a smooth cell surface configuration with very few irregularities as shown in FIG. 7 is obtained depending on the cell species. This information is displayed in the region A of the sample-information display 111.

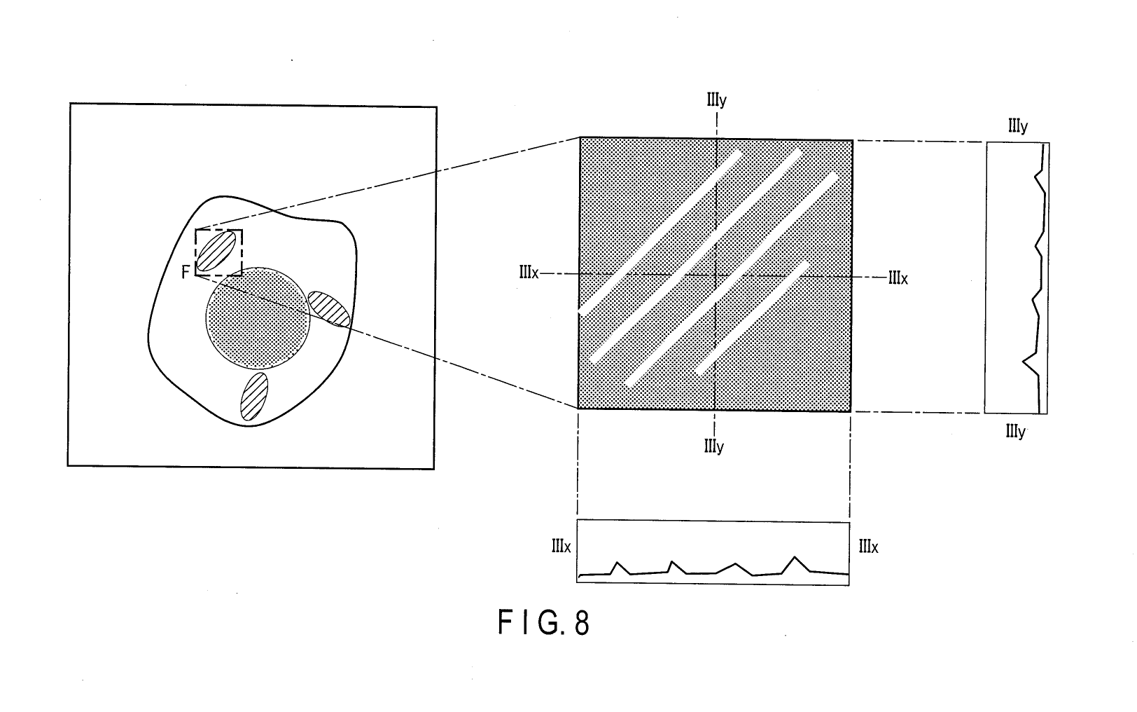

FIG. 8 shows an example where the region F of the cell shown in FIG. 6 is observed with the interaction being increased. If the interaction is large, information on a cellular interior (cell organelle) can be obtained. FIG. 8 shows an image obtained by imaging, for example, a cytoskeleton (actin filament). This information is displayed in the region B of the sample-information display 111.

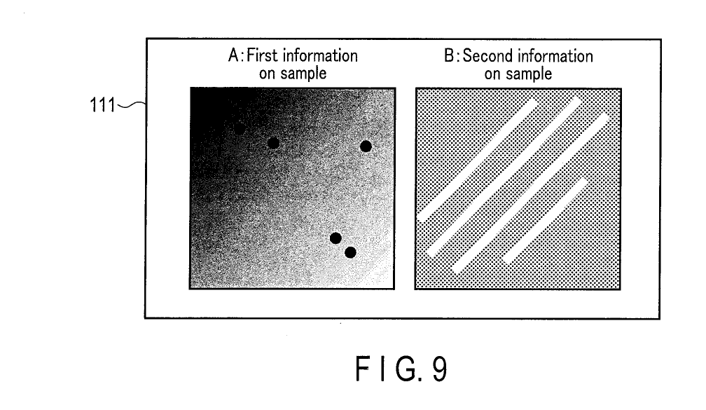

FIG. 9 shows an example of an observation image displayed on the sample-information display by the information acquiring method according to the present embodiment, and shows a state where displaying the first information on the sample 103 when the interaction is small and the second information on the sample 103 when the interaction is large for all the lines in the regions A and B of the sample-information display 111, respectively, has completed.

In this way, according to the information acquiring method according to the present embodiment, it is possible to acquire the surface information and the internal information on a cell at approximately the same time, so as to allow obtaining information on the mutual relationship between them.

### Second Embodiment

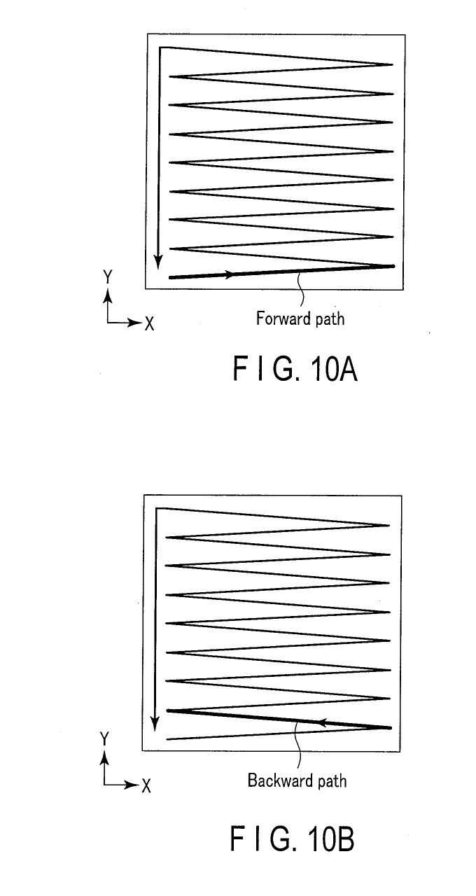

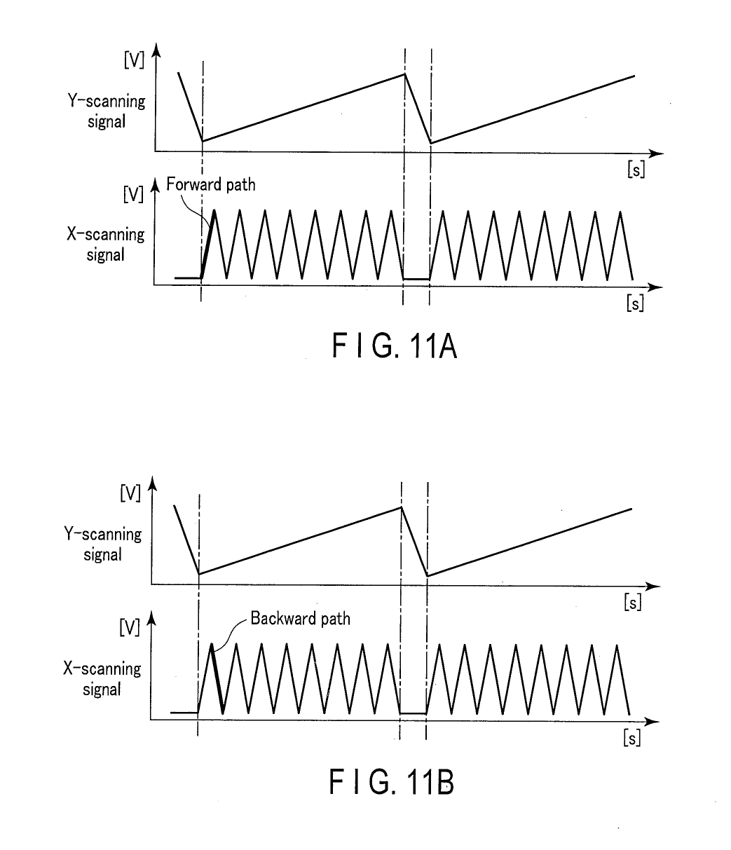

Prior to explanations of embodiments of an information acquiring method in an atomic force microscope according to a second embodiment, a forward path and a backward path of the scanning line of the raster scanning will be explained using FIGS. 10A, 10B, 11A, and 11B.

FIGS. 10A and 10B show the movement of the raster scanning of the cantilever with respect to the sample, and these figures respectively highlight a forward path and a backward path of the single scanning line of the raster scanning. FIGS. 11A and 11B show an X-scanning signal and a Y-scanning signal for performing the raster scanning, and these figures respectively highlight portions of the X-scanning signal corresponding to the forward path and backward path highlighted in FIGS. 10A and 10B.

The forward path of scanning in the raster scanning is in a +X direction as shown in FIG. 10A, and the X-scanning signal corresponding thereto is an upward-sloping portion as shown in FIG. 11B.

The backward path of scanning of the raster scanning is in a −X direction as shown in FIG. 10B, and the X-scanning signal corresponding thereto is a downward-sloping portion as shown in FIG. 11B.

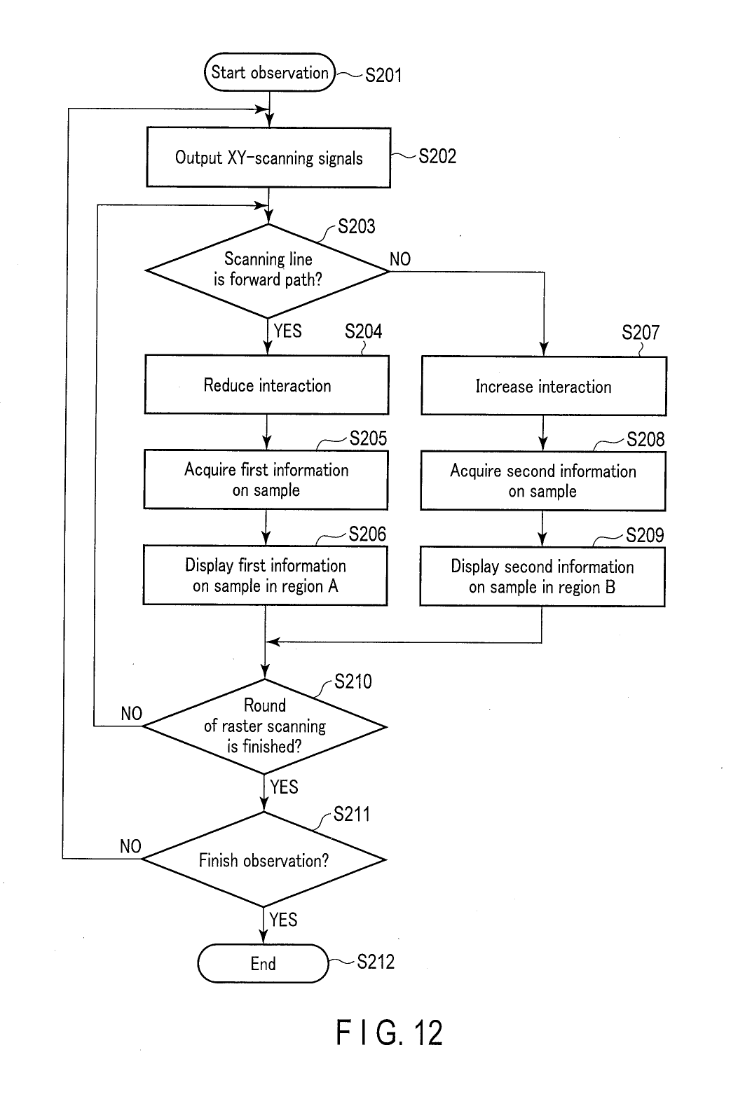

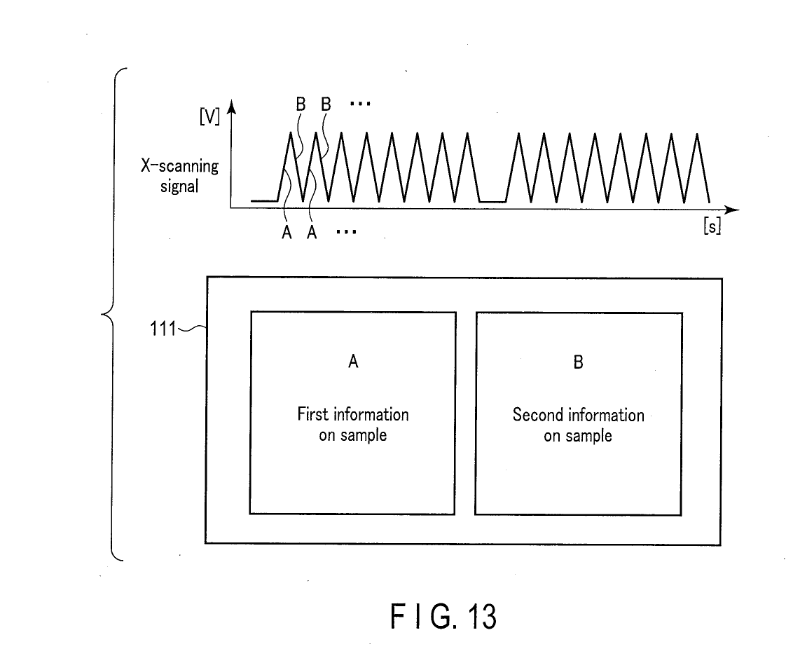

Next, an information acquiring method in an atomic force microscope according to a second embodiment will be explained using FIGS. 12 and 13. FIG. 12 is a flowchart of the information acquiring method in an atomic force microscope according to the second embodiment. FIG. 13 shows an X-scanning signal, and first information on a sample 103 and second information on the sample 103 displayed on the sample-information display 111, in the information acquiring method according to the second embodiment.

In comparison between the first embodiment and the second embodiment, in the first embodiment, the first information on the sample 103 and the second information on the sample 103 are alternately acquired for the back-and-forth movement of the scanning in the X direction as a unit, whereas, in the second embodiment, the first information on the sample 103 and the second information on the sample 103 are alternately acquired for a half of the back-and-forth movement, i.e., the forward path or the backward path, of the scanning in the X direction as a unit.

In step S201, observation (acquisition of information on a sample) is started. Details of step S201 is similar to step S101, so the details are omitted.

In step S202, the controller 110 outputs the X-scanning signal and the Y-scanning signal. The XY-scanner 108 receives the X-scanning signal and the Y-scanning signal to start the raster scanning of the sample 103 with respect to the cantilever 102 across the XY-plane.

In step S203, the controller 110 determines whether the present scanning line (scanning line based on the X-scanning signal) of the raster scanning is the forward path or the backward path. Herein, it is assumed that the single scanning line corresponds to one of the forward path or the backward path relating to the X direction.

As a result of the determination in step S203, if the present scanning line is the forward path, the controller 110 adjusts, in step S204, a relative distance between the cantilever 102 and the sample 103 along the Z direction to adjust the mechanical interaction between the cantilever 102 and the sample 103, causing a first interaction having a first strength to be generated between the probe 101 and the sample 103. For example, the controller 110 increases the relative distance between the cantilever 102 and the sample 103 along the Z direction to reduce the mechanical interaction between the probe 101 and the sample 103, causing the first interaction having the first strength to be generated between the probe 101 and the sample 103.

In step S205, the controller 110 generates and acquires image data for the single forward path for mapping the first information on the sample 103, i.e., first information on the sample 103 for the single forward path, based on the X-scanning signal, the Y-scanning signal, and the Z-scanning signal. The first information on the sample 103 is information on the sample when a small interaction is generated between the probe 101 and the sample 103, e.g., information on a surface of the sample.

In step S206, the sample-information display 111 displays the image data for the single forward path acquired by the controller 110, i.e., the first information on the sample 103 for the single forward path, in a region A shown in FIG. 13 for the single forward path. If the scanning line is the forward path, namely, if the X-scanning signal is present in a range A shown in FIG. 13, the sample-information display 111 displays the first information on the sample 103 in the region A shown in FIG. 13.

As a result of the determination in step S203, if the present scanning line is the backward path, the controller 110 reduces, in step S207, the relative distance between the cantilever 102 and the sample 103 along the Z direction to increase the mechanical interaction between the probe 101 and the sample 103, causing a second interaction having a second strength to be generated between the probe 101 and the sample 103. The second strength of the second interaction is larger than the first strength of the first interaction.

In step S208, the controller 110 generates and acquires image data for the single backward path for mapping the second information on the sample 103, i.e., second information on the sample 103 for the single backward path, based on the X-scanning signal, the Y-scanning signal, and the Z-scanning signal. The second information on the sample 103 is sample information when a large interaction is generated between the probe 101 and the sample 103, for example, it is information on the sample's interior.

In step S209, the sample-information display 111 displays the image data for the single backward path acquired by the controller 110, i.e., the second information on the sample 103 for the single backward path, in a region B shown in FIG. 13 for the single backward path. If the scanning line is the backward path, namely, if the X-scanning signal is present in a range B shown in FIG. 13, the sample-information display 111 displays the second information on the sample 103 in the region B shown in FIG. 13.

After step S206 or step S209, in step S210, the controller 110 determines whether a round of the raster scanning is finished or not. As a result of the determination in step S210, if the round of the raster scanning has not been finished, the controller 110 returns to step S203 and repeats the steps S203 to S210 until the round of the raster scanning is finished.

At the point in time when the round of the raster scanning is finished, displaying the first information on the sample 103 when the interaction is small and the second information on the sample 103 when the interaction is large, in the region A and the region B shown in FIG. 13 for all scanning lines, has become completed.

The controller 110 determines, in step S211, whether to finish the observation, in other words, whether to perform the observation once more.

As a result of the determination in step S211, if the observation should be performed once more, the controller 110 returns to step S202.

As a result of the determination in step S211, if the observation needs to be finished, the observation is finished in step S212.

The information acquiring method according to the present embodiment alternately acquires the first information on the sample 103 when the small interaction is generated and the second information on the sample 103 when the large interaction is generated for the forward path and the backward path of the raster scanning, respectively, in other words, at temporally equal intervals. This is deemed that two kinds of information on the sample are acquired at approximately the same time. Therefore, it is possible to acquire the information on the mutual relationship between them.

According to also the present embodiment, it is possible to acquire the surface information and the internal information on a cell at approximately the same time, so as to allow obtaining information on the mutual relationship between them.

### Modification

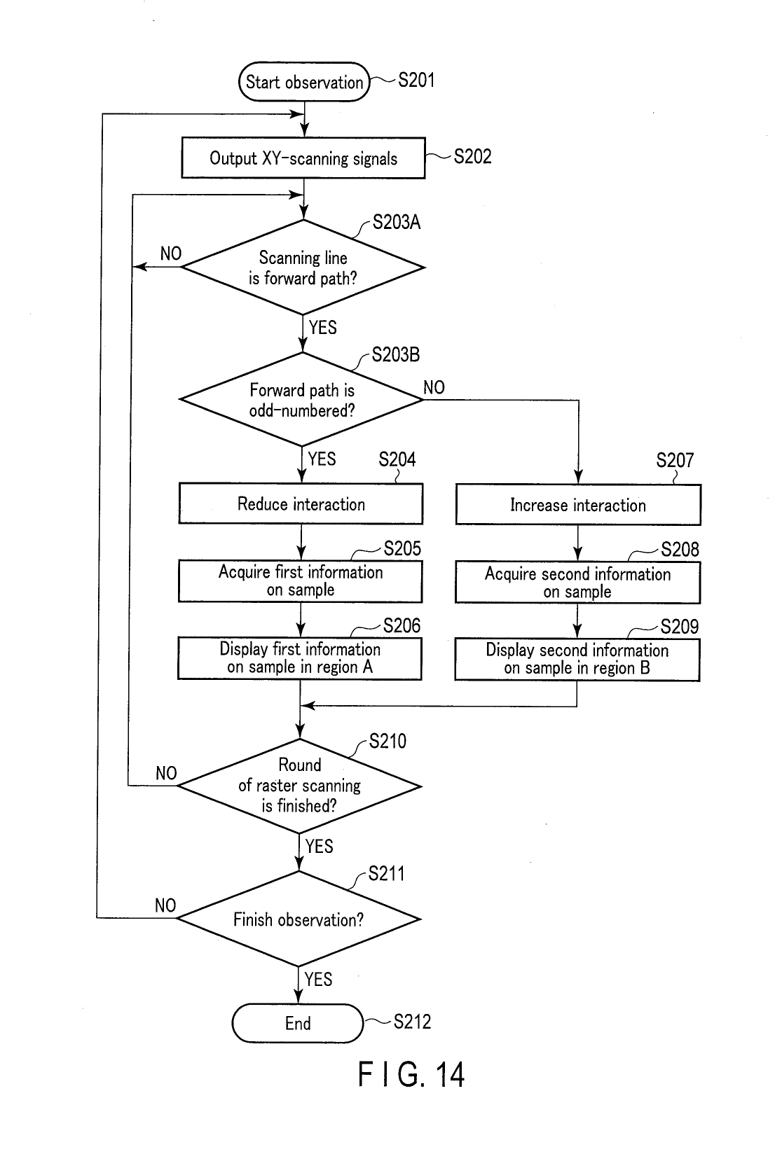

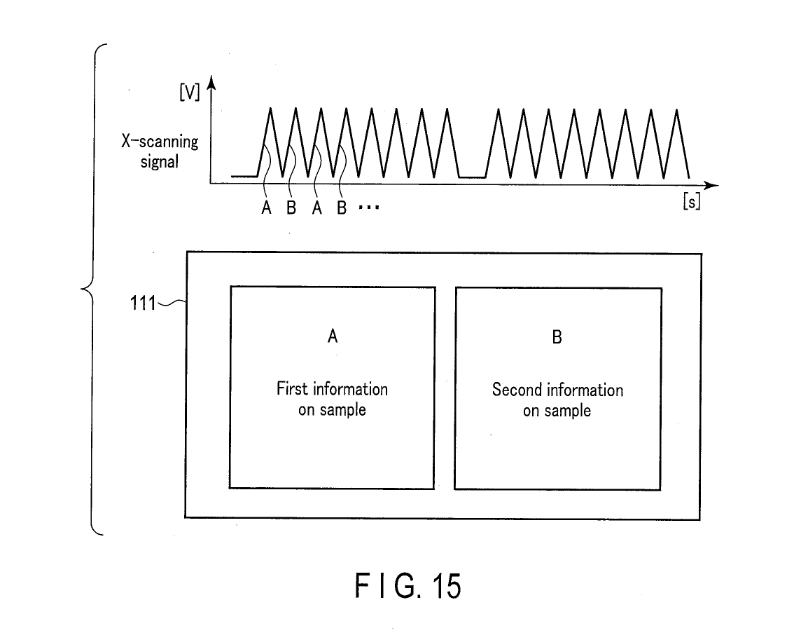

Next, an information acquiring method in an atomic force microscope according to a modification of the second embodiment will be explained using FIGS. 14 and 15. FIG. 14 is a flow chart of the information acquiring method in an atomic force microscope according to the modification of the second embodiment. FIG. 15 shows an X-scanning signal, and first information on a sample 103 and second information on the sample 103 displayed on the sample-information display 111, in the information acquiring method according to the modification of the second embodiment.

The information acquiring method according to the present modification alternately acquires the information on the sample for only the forward path of the raster scanning, instead of alternately acquiring the information on the sample for the forward path and the backward path of the raster scanning.

In the information acquiring method according to the present modification, step S203 of the flow chart shown in FIG. 12 is replaced with steps S203A and S203B, as shown in FIG. 14.

In step S201, observation (acquisition of information on a sample) is started.

In step S202, the controller 110 outputs the X-scanning signal and the Y-scanning signal. The XY-scanner 108 receives the X-scanning signal and the Y-scanning signal to start the raster scanning of the sample 103 with respect to the cantilever 102 across the XY-plane.

In step S203A, the controller 110 determines whether the present scanning line (scanning line based on the X-scanning signal) of the raster scanning is the forward path or the backward path. Herein, it is assumed that the single scanning line corresponds to one of the forward path or the backward path relating to the X direction.

As a result of the determination in step S203A, if the present scanning line is the backward path, the controller 110 returns to step S203A again.

As a result of the determination in step S203A, if the present scanning line is the forward path, in step S203B, the controller 110 determines whether the present forward path is an odd-numbered path or an even-numbered path

As a result of the determination in step S203B, if the present scanning line is the odd-numbered path, the controller 110 increases, in step S204, a relative distance between the cantilever 102 and the sample 103 along the Z direction to decrease the mechanical interaction between the cantilever 102 and the sample 103, causing a first interaction having a first strength to be generated between the probe 101 and the sample 103.

In step S205, the controller 110 generates and acquires image data for the single forward path for mapping the first information on the sample 103, i.e., first information on the sample 103 for the single forward path, based on the X-scanning signal, the Y-scanning signal, and the Z-scanning signal. The first information on the sample 103 is information on the sample when a small interaction is generated between the probe 101 and the sample 103, e.g., information on a surface of the sample.

In step S206, the sample-information display 111 displays the image data for the single forward path acquired by the controller 110, i.e., the first information on the sample 103 for the single forward path, in a region A shown in FIG. 15 for the single forward path. If the scanning line is the odd-numbered path, namely, if the X-scanning signal is present in a range A shown in FIG. 15, the sample-information display 111 displays the first information on the sample 103 in the region A shown in FIG. 15.

As a result of the determination in step S203B, if the present scanning line is the even numbered path, the controller 110 reduces, in step S207, the relative distance between the cantilever 102 and the sample 103 along the Z direction to increase the mechanical interaction between the probe 101 and the sample 103, causing a second interaction having a second strength to be generated between the probe 101 and the sample 103. The second strength of the second interaction is larger than the first strength of the first interaction.

In step S208, the controller 110 generates and acquires image data for the single forward path for mapping the second information on the sample 103, i.e., second information on the sample 103 for the single forward path, based on the X-scanning signal, the Y-scanning signal, and the Z-scanning signal. The second information on the sample 103 is sample information when a large interaction is generated between the probe 101 and the sample 103, for example, it is information on the sample's interior.

In step S209, the sample-information display 111 displays the image data for the single forward path acquired by the controller 110, i.e., the second information on the sample 103 for the single forward path, in a region B shown in FIG. 15 for the single forward path. If the scanning line is the even-numbered forward path, namely, if the X-scanning signal is present in a range B shown in FIG. 15, the sample-information display 111 displays the second information on the sample 103 in the region B shown in FIG. 15.

After step S206 or step S209, in step S210, the controller 110 determines whether a round of the raster scanning is finished or not. As a result of the determination in step S210, if the round of the raster scanning has not been finished, the controller 110 returns to step S203A and repeats the steps S203A, S203B, and S204 to S210 until the round of the raster scanning is finished.

At the point in time when the round of the raster scanning is finished, displaying the first information on the sample 103 when the interaction is small and the second information on the sample 103 when the interaction is large, in the region A and the region B shown in FIG. 15 for all scanning lines, has become completed.

The controller 110 determines, in step S211, whether to finish the observation, in other words, whether to perform the observation once more.

As a result of the determination in step S211, if the observation should be performed once more, the controller 110 returns to step S202.

As a result of the determination in step S211, if the observation needs to be finished, the observation is finished in step S212.

In the information acquiring method according to the modification of the present embodiment, the information on the sample 103 when the small interaction is generated and the information on the sample 103 when the large interaction is generated are alternately acquired for only the forward path of the raster scanning. This is deemed that the two kinds of information on the sample are acquired at approximately the same time. Therefore, it is possible to acquire the information on the mutual relationship between them.

Herein, an example of alternately acquiring the information on the sample for only the forward path of the raster scanning has been cited, but it may be modified so as to alternately acquire the information on the sample for only the backward path of the raster scanning, which provides the same effect.

### Third Embodiment

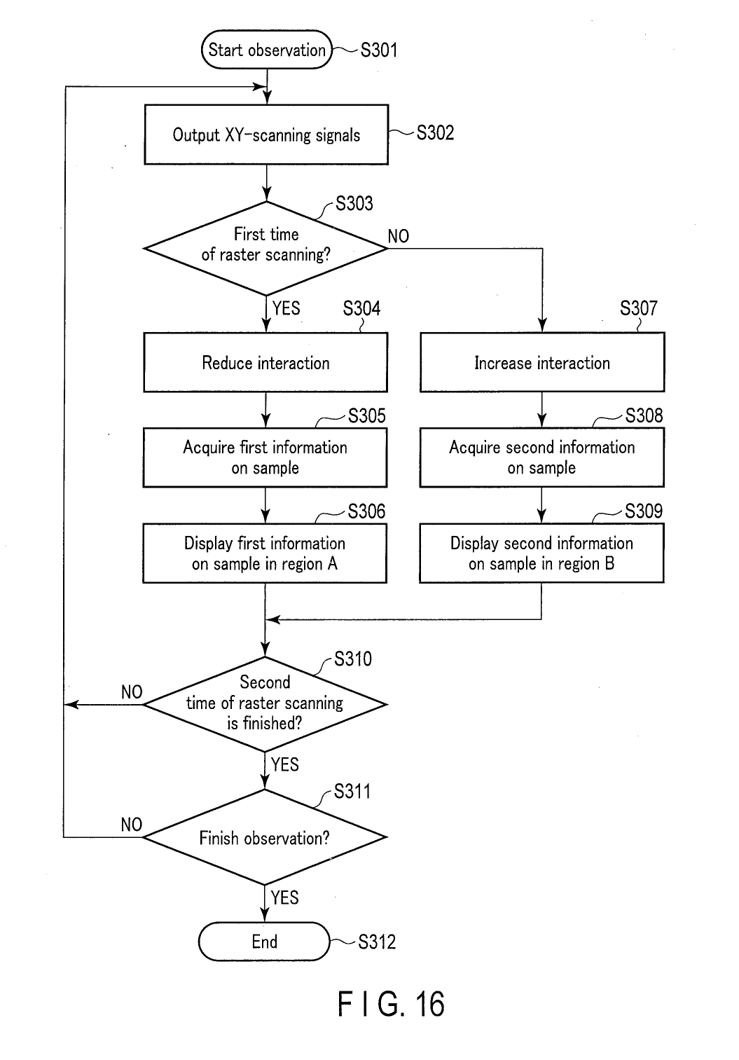

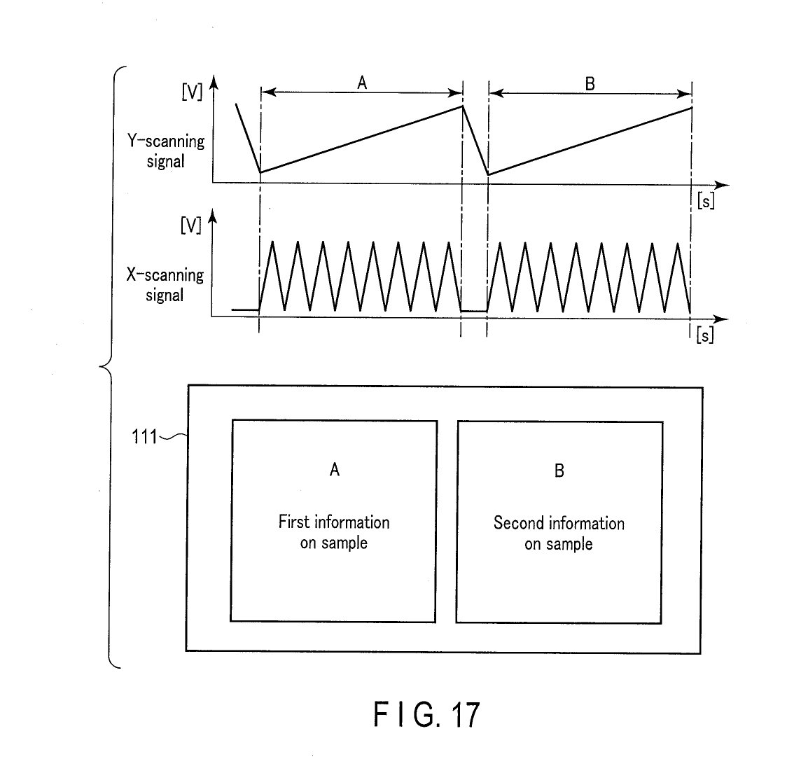

An information acquiring method in an atomic force microscope according to a first embodiment will be explained using FIGS. 16 and 17. FIG. 16 is a flow chart of the information acquiring method in an atomic force microscope according to the third embodiment. FIG. 17 shows an X-scanning signal and a Y-scanning signal, and first information on a sample 103 and second information on the sample 103 displayed on the sample-information display 111, in the information acquiring method according to the third embodiment.

The information acquiring method according to the present embodiment is a technique of performing the raster scanning for an observation region alternately at least once, i.e., alternately performing a first raster scanning and a second raster scanning, and acquiring the first information on the sample 103 during the first time of raster scanning, the first raster scanning, and the second information on the sample 103 during the second time of raster scanning, the second raster scanning.

In step S301, observation (acquisition of information on a sample) is started. Details of step S301 is similar to step S101, so the details are omitted.

In step S302, the controller 110 outputs the X-scanning signal and the Y-scanning signal. The XY-scanner 108 receives the X-scanning signal and the Y-scanning signal to start the raster scanning of the sample 103 with respect to the cantilever 102 across the XY-plane.

In step S303, the controller 110 determines whether the present raster scanning is the first time of raster scanning or not.

As a result of the determination in step S303, if the present raster scanning is the first time of raster scanning, the controller 110 increases, in step S304, the relative distance between the cantilever 102 and the sample 103 along the Z direction to reduce the mechanical interaction between the probe 101 and the sample 103, causing the first interaction having the first strength to be generated between the probe 101 and the sample 103.

In step S305, the controller 110 generates and acquires image data for mapping the first information on the sample 103, based on the X-scanning signal, the Y-scanning signal, and the Z-scanning signal. The first information on the sample 103 is information on the sample when a small interaction is generated between the probe 101 and the sample 103, e.g., information on a surface of the sample. The first raster scanning includes step S304 and step S305.

In step S306, the sample-information display 111 displays the image data for a round of the raster scanning acquired by the controller 110, i.e., the first information on the sample 103, in a region A shown in FIG. 17. If the Y-scanning signal is present in a range A shown in FIG. 17, the sample-information display 111 displays the first information on the sample 103 in the region A shown in FIG. 17.

As a result of the determination in step S303, if the present raster scanning is not the first time of raster scanning, the controller 110 reduces, in step S307, the relative distance between the cantilever 102 and the sample 103 along the Z direction to increase the mechanical interaction between the probe 101 and the sample 103, causing a second interaction having a second strength to be generated between the probe 101 and the sample 103. The second strength of the second interaction is larger than the first strength of the first interaction.

In step S308, the controller 110 generates and acquires image data for mapping the second information on the sample 103, i.e., second information on the sample 103, based on the X-scanning signal, the Y-scanning signal, and the Z-scanning signal. The second information on the sample 103 is sample information when a large interaction is generated between the probe 101 and the sample 103, for example, it is information on the sample's interior.

In step S309, the sample-information display 111 displays the image data for the round of the raster scanning acquired by the controller 110, i.e., the second information on the sample 103, in a region B shown in FIG. 17. If the X-scanning signal is present in a range B shown in FIG. 17, the sample-information display 111 displays the second information on the sample 103 in the region B shown in FIG. 17.

After step S306 or step S309, in step S310, the controller 110 determines whether the second time of raster scanning is finished or not.

As a result of the determination in step S310, if the second time of raster scanning has not been finished, the controller 110 returns to step S302 and repeats the steps S302 to S310 until the second time of raster scanning is finished.

At the point in time when the second time of raster scanning is finished, displaying the first information on the sample 103 when the interaction is small and the second information on the sample 103 when the interaction is large, in the region A and the region B shown in FIG. 17, has become completed.

As a result of the determination in step S310, if the second time of raster scanning has been finished, the controller 110 determines, in step S311, whether to finish the observation, in other words, whether to perform the observation once more.

As a result of the determination in step S311, if the observation should be performed once more, the controller 110 returns to step S302.

As a result of the determination in step S311, if the observation needs to be finished, the observation is finished in step S312.

The information acquiring method according to the present embodiment alternately performs the first raster scanning and the second raster scanning at least once. This allows that the first information on the sample 103 when the small interaction is generated and the second information on the sample 103 when the large interaction is generated are alternately acquired at least once at temporally equal intervals corresponding to scanning for the round of the raster scanning. This is deemed that, if the scanning speed is sufficiently fast, the two kinds of information on the sample are acquired at approximately the same time. Therefore, it is possible to acquire the information on the mutual relationship between them.

According to also the present embodiment, it is possible to acquire the surface information and the internal information on a cell at approximately the same time, so as to allow obtaining information on the mutual relationship between them.

### Fourth Embodiment

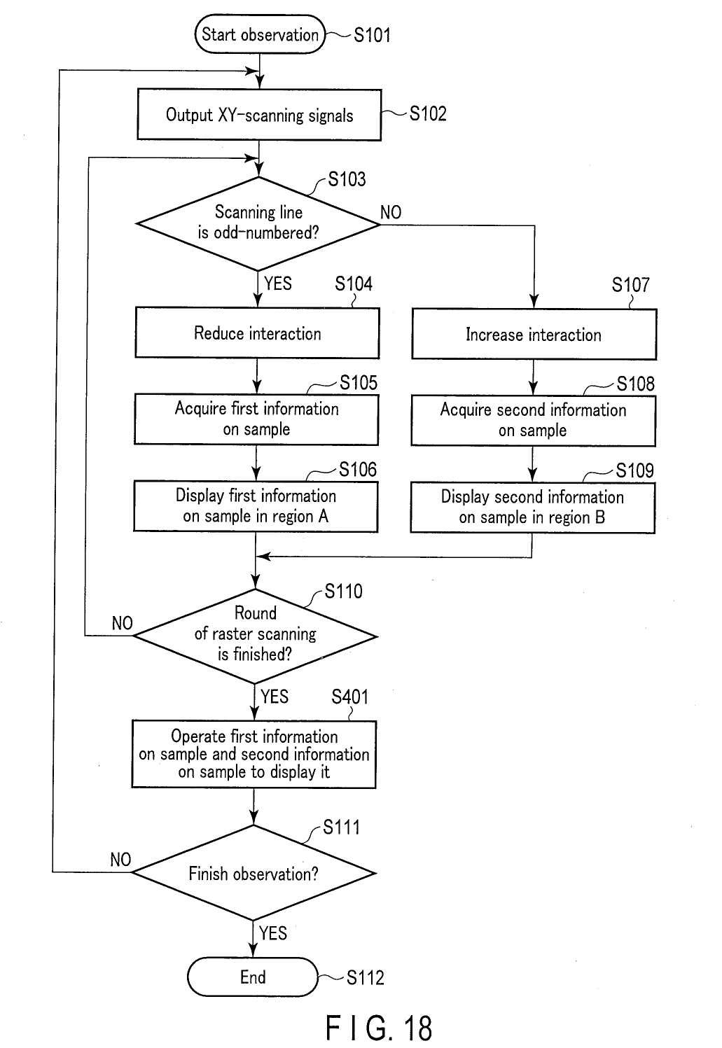

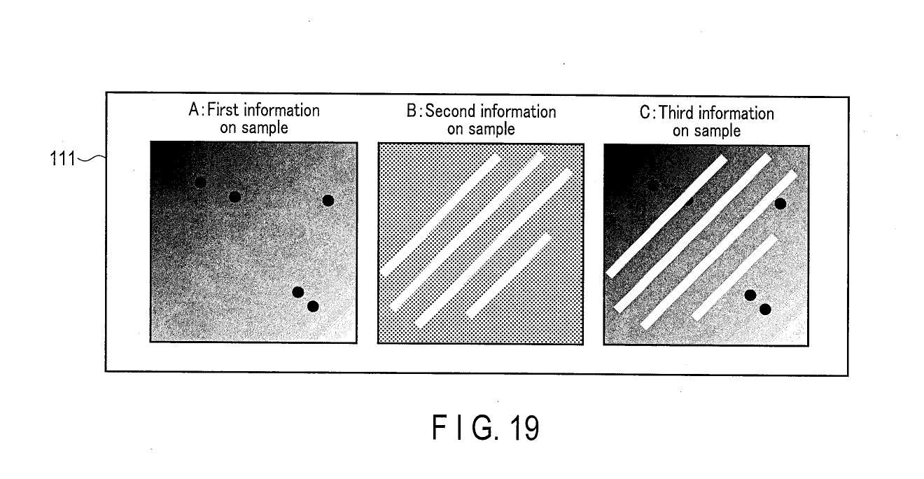

An information acquiring method according to a fourth embodiment will be explained using FIGS. 18 and 19. FIG. 18 is a flow chart of the information acquiring method according to the fourth embodiment. FIG. 19 shows an example of an observation image displayed on the sample-information display by the information acquiring method according to the fourth embodiment

The information acquiring method according to the present embodiment is similar to the information acquiring method according to the first embodiment. As can be understood from a comparison between FIG. 4 and FIG. 18, the information acquiring method according to the present embodiment has step S401 to operate first information on a sample 103 and second information on the sample 103 and display it between step S110 and step S111, in addition to the various steps of the information acquiring method according to the first embodiment. In step S401, the controller 110 operates the first information on the sample 103 when the interaction is small and the second information on the sample 103 when the interaction is large displayed respectively in a region A and a region B to acquire third information on the sample 103. The sample-information display 111 displays the third information on the sample 103 acquired by the controller 110 in a region C shown in FIG. 19. The operation to acquire the third information on the sample 103 may be, for example, a composite operation, i.e., an addition, however; the operation, such as subtraction, division, etc., but not limited to that, is desirably used depending on information to be acquired.

FIG. 19. shows the third information on the sample 103, which is composed the first information and the second information on the sample 103, displayed in the region C, in addition to the first information on the sample 103 in region A and the second information on the sample 103 displayed in the region B on the sample-information display 111.

In this way, in the present embodiment, surface information and inside information on a cell can be acquired at approximately the same time, and a positional relationship between the surface and the inside of the cell can be made clear by combining the information. This allows obtaining more detailed information on a mutual relationship between the surface and the interior.

### Fifth Embodiment

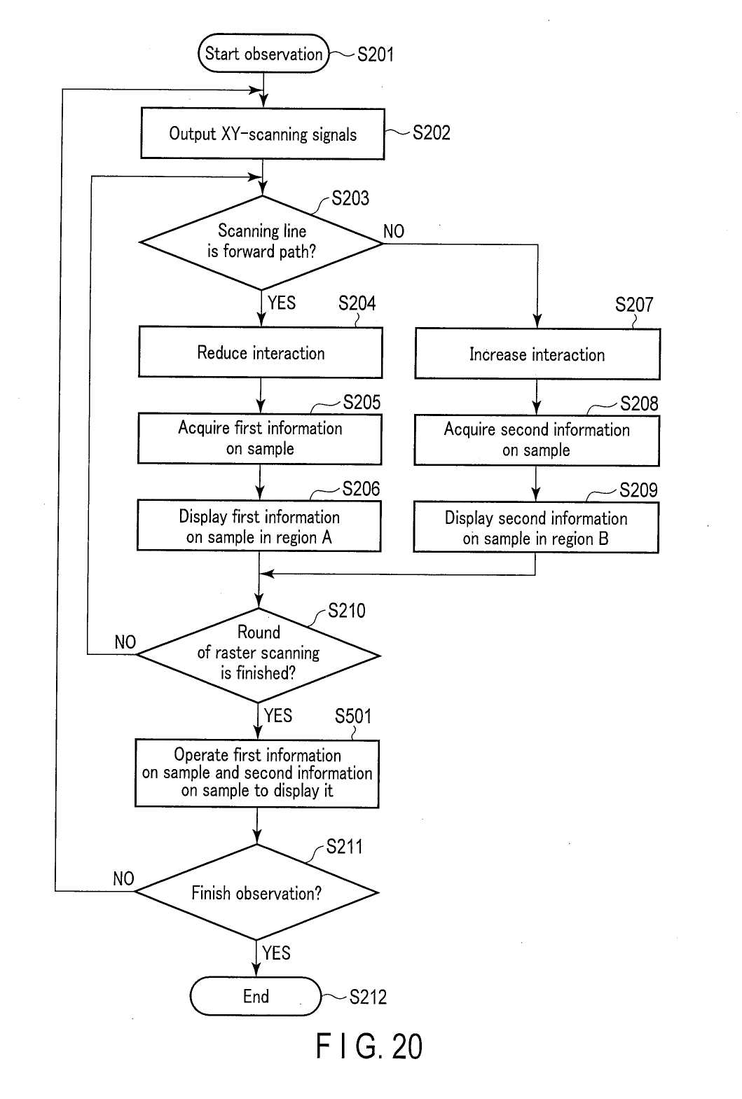

An information acquiring method according to a fifth embodiment will be explained using FIG. 20. FIG. 20 is a flow chart of the information acquiring method according to the fifth embodiment. The information acquiring method according to the present embodiment is similar to the information acquiring method according to the second embodiment. As can be understood from a comparison between FIG. 12 and FIG. 20, the information acquiring method according to the present embodiment has step S501 to operate first information on a sample 103 and second information on the sample 103 and display it between step S210 and step S211, in addition to the various steps of the information acquiring method according to the second embodiment. In step S501, the controller 110 operates the first information on the sample 103 when the interaction is small and the second information on the sample 103 when the interaction is large displayed respectively in a region A and a region B to acquire third information on the sample 103. The sample-information display 111 displays the third information on the sample 103 acquired by the controller 110. The operation to acquire the third information on the sample 103 may be, for example, a composite operation, i.e., an addition, however; the operation, such as subtraction, division, etc., but not limited to that, is desirably used depending on information to be acquired.

In this way, in the present embodiment, surface information and inside information on a cell can be acquired at approximately the same time, and a positional relationship between the surface and the inside of the cell can be made clear by combining the information. This allows obtaining more detailed information on a mutual relationship between the surface and the interior.

### Sixth Embodiment

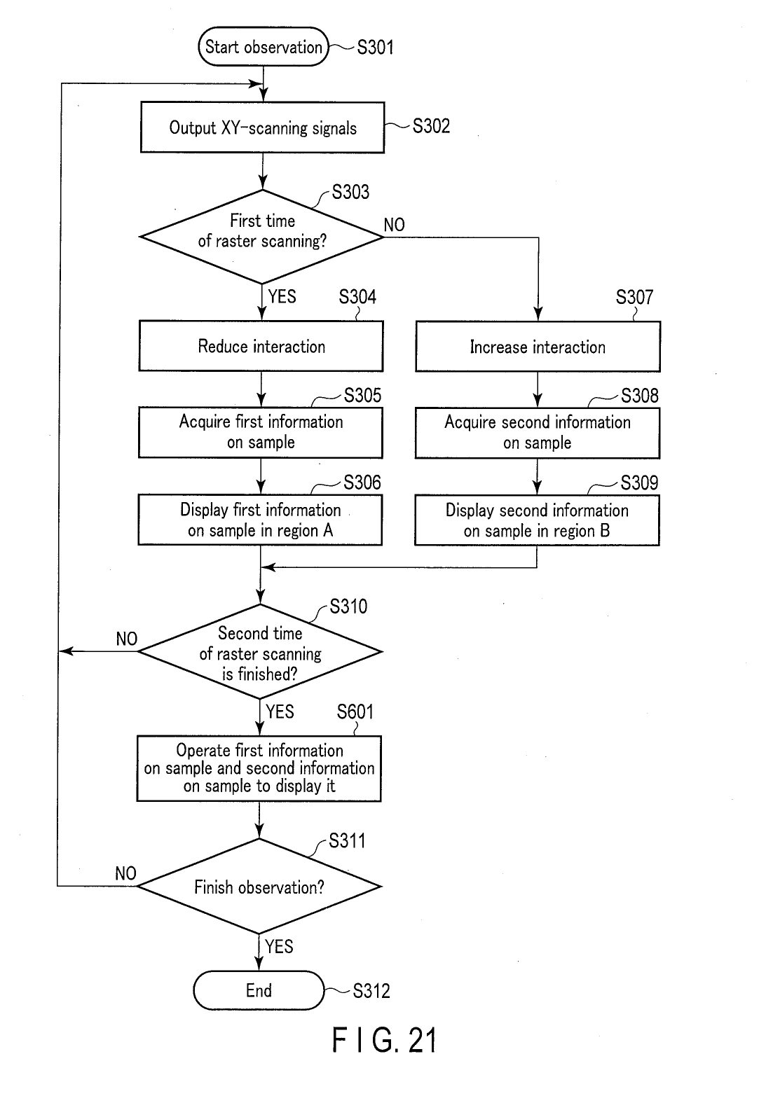

An information acquiring method according to a sixth embodiment will be explained using FIG. 21. FIG. 21 is a flow chart of the information acquiring method according to the sixth embodiment. The information acquiring method according to the present embodiment is similar to the information acquiring method according to the third embodiment. As can be understood from a comparison between FIG. 16 and FIG. 21, the information acquiring method according to the present embodiment has step S601 to operate first information on a sample 103 and second information on the sample 103 between step S310 and step S311, in addition to the various steps of the information acquiring method according to the third embodiment. In step S601, the controller 110 operates the first information on the sample 103 when the interaction is small and the second information on the sample 103 when the interaction is large displayed respectively in a region A and a region B to acquire third information on the sample 103. A sample-information display 111 displays the third information on the sample 103 acquired by the controller 110. The operation to acquire the third information on the sample 103 may be, for example, a composite operation, i.e., an addition, however; the operation, such as subtraction, division, etc., but not limited to that, is desirably used depending on the information to be acquired.

In this way, in the present embodiment, surface information and interior information on a cell can be acquired at approximately the same time, and a positional relationship between the surface and the inside of the cell can be made clear by combining the information. This allows obtaining more detailed information on a mutual relationship between the surface and the interior.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information acquiring method in an atomic force microscope to acquire information on a sample by raster scanning a cantilever and the sample relatively across an XY-plane, while contacting a probe provided at a free end of the cantilever with the sample to cause a mechanical interaction to be generated between the probe and the sample, the method comprising:
causing a first interaction having a first strength to be generated between the probe and the sample;
acquiring first information on the sample when the first interaction is generated between the probe and the sample;
causing a second interaction having a second strength different from the first strength to be generated between the probe and the sample; and
acquiring second information on the sample when the second interaction is generated between the probe and the sample,
the causing the first interaction to be generated and the acquiring the first information, and the causing the second interaction to be generated and the acquiring the second information being performed in a same scanning region.

2. The information acquiring method in an atomic force microscope according to claim 1, wherein the causing the first interaction to be generated and the acquiring the first information, and the causing the second interaction to be generated and the acquiring the second information are alternately repeated for each scanning line of the raster scanning.

3. The information acquiring method in an atomic force microscope according to claim 2, wherein the scanning line of the raster scanning is at least one of a forward path and a backward path of the scanning.

4. The information acquiring method in an atomic force microscope according to claim 1, comprising:
performing a first raster scanning including the causing the first interaction to be generated and the acquiring the first information; and
performing a second raster scanning including the causing the second interaction to be generated and the acquiring the second information,
the performing the first raster scanning and the performing the second raster scanning being performed alternately at least once.

5. The information acquiring method in an atomic force microscope according to claim 1, comprising
alternately and respectively displaying the first information on the sample and the second information on the sample in an updated manner at temporally equal intervals.

6. The information acquiring method in an atomic force microscope according to claim 1, wherein the second strength of the second interaction is larger than the first strength of the first interaction, the sample is a cell, the first information on the sample is information on a surface of the cell, and the second information on the sample is information on an interior of the cell.

7. The information acquiring method in an atomic force microscope according to claim 1, further comprising:
generating third information on the sample by operating the first information on the sample and the second information on the sample.

8. The information acquiring method in an atomic force microscope according to claim 7, wherein the operating is a composite operation.

9. The information acquiring method in an atomic force microscope according to claim 7, further comprising
displaying the third information on the sample.

10. A program product including a program that causes an atomic force microscope to execute the information acquiring method in an atomic force microscope according to claim 1.

11. An atomic force microscope in which the program included in the program product according to claim 10 is installed.
